(19) United States
(12) Patent Application Publication
(10) Pub. No.: US 2015/0097450 A1
(43) Pub. Date: Apr. 9, 2015

(54) SYSTEM AND METHOD FOR COOLING AN ELECTRIC MOTOR

(71) Applicants: Zhihai Xu, ShangHai (CN); Kuifeng Li, ShangHai (CN)

(72) Inventors: Zhihai Xu, ShangHai (CN); Kuifeng Li, ShangHai (CN)

(21) Appl. No.: 14/391,331

(22) PCT Filed: Apr. 10, 2012
(86) PCT No.: PCT/CN2012/073690

§ 371 Date: Oct. 8, 2014

(51) Int. Cl. H02K 9/197; H02K 5/20

(52) U.S. Cl. CPC H02K 9/197; H02K 5/20
USPC 310/54

(57) ABSTRACT

A frame for an electric motor, the frame including an outer frame layer, an inner frame layer, and a liquid coolant passage positioned between the inner frame layer and the outer frame layer, wherein the inner frame layer includes a first opening to allow air from an air passage among a rotor of the electric motor to flow between the inner frame layer and the outer frame layer and across the liquid coolant passage. Therefore, interior components of the electric motor may be cooled.

### FIELD

Embodiments of the subject matter disclosed herein relate to cooling an electric motor.

### BACKGROUND

Electric motors used in various industrial applications such as drilling, pumping, pipeline compression, etc. typically have high torque demands. In order to meet the high torque demands of such applications, an electric motor comprises a stator and a rotor that are large enough to generate an electromagnetic inductive force that is strong enough to meet the torque demand. During operation of the electric motor, these large components generate a substantial amount of heat. For example, heat may be generated from the electromagnetic induction between the stator and the rotor. As another example, heat may be generated from friction due to rotation of the rotor during operation of the electric motor. The electric motor may be cooled in various ways in order to dissipate heat generated during operation.

In one example, an external cooling system may be coupled to an electric motor to provide cooling. The external cooling system comprises fans or blowers powered by an external power source to provide forced air to an exterior of the electric motor. In a case where interior components (e.g., stator and rotor) of the electric motor are sealed from an exterior environment, cooling performance may be reduced relative to an open motor arrangement because the forced air provided by the external cooling system does not reach the interior components of the electric motor. Accordingly, operation of the sealed electric motor may be limited to prevent overheating of the interior components.

In a case where the interior components of the electric motor are exposed to the exterior environment, cooling performance may be increased relative to a sealed motor arrangement because the forced air provided by the external cooling system reaches the interior components of the electric motor. However, this type of electric motor may be more susceptible to other environmental conditions (e.g., high humidity, dust contamination) that may cause degradation of the electric motor.

In either case, the external cooling system generates noise at a level above and beyond a level of noise generated during operation of the electric motor. Such noise levels may be undesirable to operators of the electric motor. Furthermore, since the external cooling system is powered by an external power source, operation of the external cooling system consumes power beyond power consumed to operate the electric motor.

### BRIEF DESCRIPTION

Various methods and apparatuses are provided for cooling an electric motor. In one embodiment, a frame for an electric motor comprises an outer frame layer, an inner frame layer, and a liquid coolant passage positioned between the inner frame layer and the outer frame layer. The inner frame layer comprises a first opening to allow air from an air passage among a rotor of the electric motor to flow between the inner frame layer and the outer frame layer and across the liquid coolant passage.

By providing a liquid coolant passage between layers of the frame and allowing air from the air passage among internal components of the electric motor to flow across the liquid coolant passage, heat may be transferred from air flowing through the interior of the electric motor to liquid coolant flowing through the liquid coolant passage, and further from the liquid coolant passage to an exterior environment when the liquid coolant is expelled from the liquid coolant passage. In this way, interior components of the electric motor may be cooled.

Furthermore, in some embodiments, the electric motor comprises a fan to blow air through the air passage. The fan increases the flow rate of air across the liquid coolant passage to increase the cooling performance of the electric motor. In one example, the fan is operatively coupled to the rotor such that the fan blows air during rotation of the rotor. Since the fan is operatively coupled to the rotor, the fan operates during operation of the electric motor without additional power consumption from an external power source. In this way, less power is consumed to cool the electric motor relative to an arrangement where an external cooling system that is powered by an external power source is used to cool an electric motor.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a cross-sectional view of an embodiment of an electric motor according to the present description.

FIG. 2 shows a partial cross-sectional view of the electric motor that is perpendicular to the cross-sectional view of FIG. 1.

FIG. 3 shows a partial cut-away view of a frame for an electric motor according to the present description.

FIG. 4 shows an embodiment of a method for cooling an electric motor.

### DETAILED DESCRIPTION

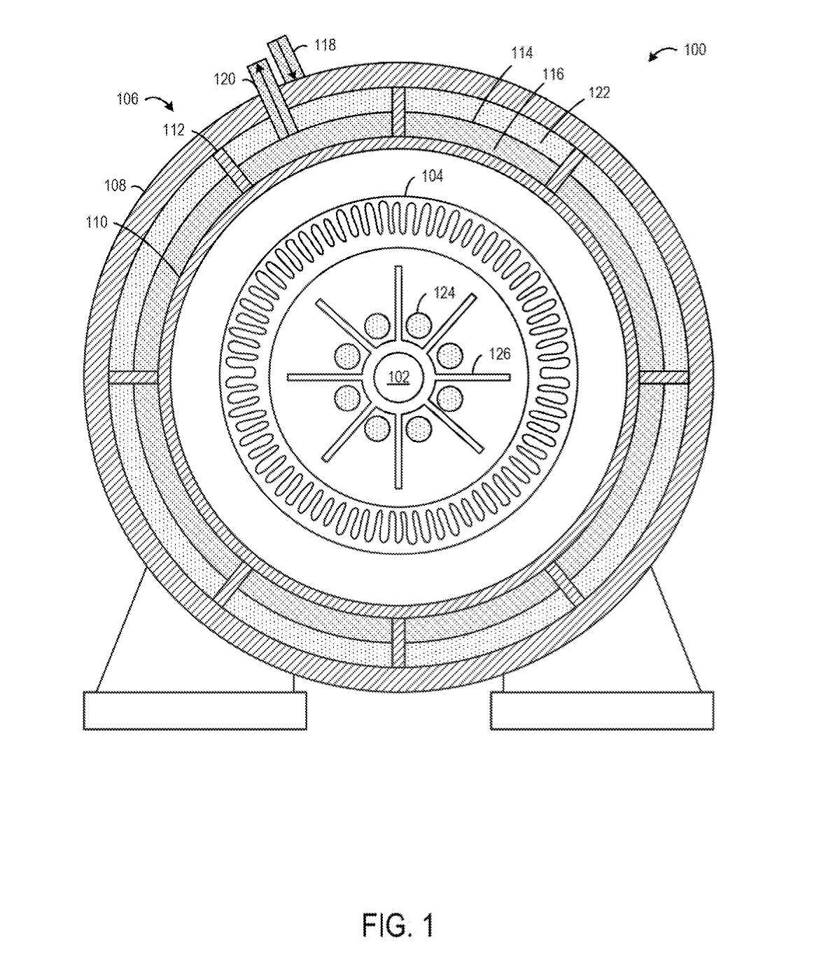

The present description relates to various embodiments of systems and methods for cooling an electric motor. More particularly, the present description relates to cooling interior components of an electric motor using a combination of liquid cooling and air cooling. FIG. 1 shows a cross-sectional view of an embodiment of an electric motor 100 according to the present description. The electric motor 100 can be used in various industrial applications such as drilling, pumping, etc. In some applications, the electric motor 100 may be stationary or at least stationary during operation. For example, the electric motor 100 may be fixed with respect to one reference, such as fixed with respect to a support or platform. In this example, the electric motor 100 remains in the fixed position on the support during operation. But, the support may be moved when the electric motor 100 is not operating in order to reposition the electric motor 100. In another example, the electric motor 100 could be fixed with respect to two references, such as fixed with respect to a support and the support is fixed geographically. In this example, the electric motor 100 remains fixed in the same position when operating as well as when not operating. In some applications, the electric motor 100 may be fixed with respect to a support and the support may be moved when the electric motor 100 is operating.

Typically, the electric motor 100 is operated in the atmosphere and not immersed in water. As such, the electric motor 100 cannot be passed through water to provide cooling. Instead, water or another liquid coolant is brought to the electric motor 100 for cooling. In one particular example, the electric motor 100 is mounted to a drilling platform and provides torque output to operate a drill. The drill platform may be positioned on or near salt water, such as on an ocean or a coastline and salt water is pumped to the electric motor 100 for cooling.

It will be appreciated that the electric motor 100 may assume various suitable forms without departing from the scope of the present description. In the illustrated embodiment, the electric motor 100 comprises a rotor 102 and a stator 104 that surrounds the rotor 102. The electric motor 100 may be driven by alternating current. More particularly, the electric motor may be an induction motor where current is applied to the stator 104 to generate a rotative magnetic field that is transferred to the rotor 102 by electromagnetic induction that causes rotation of the rotor 102 to provide torque output of the electric motor 100.

The electric motor 100 comprises a frame 106 that contains the rotor 102 and the stator 104. In the illustrated embodiment, the frame 106 is cylindrical, although it will be appreciated that the frame may take various suitable shapes without departing from the scope of the present description. The frame 106 comprises an outer frame layer 108 and an inner frame layer 110. The outer frame layer 108 is separated from the inner frame layer by a plurality of support bars 112. In one particular example, eighteen support bars are spaced throughout the frame 106 to separate the outer frame layer 108 and the inner frame layer 110. In some embodiments, the outer frame layer 108 and the inner frame layer 110 have different thicknesses (e.g., different radial thicknesses).

In some embodiments, the outer frame layer 108 encloses the rotor 102 and the stator 104 and seals the interior of the electric motor 100 off from an exterior environment. In other words, internal components and passages of the electric motor 100 are not exposed to the exterior environment and conditions associated with the environment, such as ambient humidity or the like. It will be appreciated that the rotor 102 may extend beyond the outer frame layer 108 to provide torque output, but the outer frame layer 108 may provide a seal around the rotor 102 to prevent the internal components of the electric motor 100 from being exposed to exterior environmental conditions.

The separation between the outer frame layer 108 and the inner frame layer 110 allows for a structure 114 that defines a liquid coolant passage 116 to be positioned between the inner frame layer 110 and the outer frame layer 108. The coolant passage 116 comprises a liquid coolant inlet 118 configured to receive a liquid coolant from an exterior environment and a coolant outlet 120 to expel the liquid coolant from the liquid coolant passage 116 to the exterior environment. Liquid coolant that is pumped into the liquid coolant inlet 118 flows through the liquid coolant passage 116 and is expelled from the liquid coolant outlet 120 to cool the electric motor 100. In particular, heat may be transferred from the internal components (e.g., stator, rotor) of the electric motor 100 to liquid coolant flowing through the liquid coolant passage 116, which is expelled from the liquid coolant passage 116 to cool the electric motor 100.

In the illustrated embodiment, the liquid coolant passage 116 surrounds the inner frame layer 110 and spans a length of the inner frame layer 110. The structure 114 that defines the liquid coolant passage 116 is coupled to the inner frame layer 110. Further, the liquid coolant passage 116 and the structure 114 do not fill the space separating the outer frame layer 108 and the inner frame layer 110. Rather, the structure 114 and the outer frame layer 108 define an air passage 122 that allows air to travel across the liquid coolant passage 116. In some embodiments, the structure 114 that defines the liquid coolant passage 116 may be coupled to the outer frame layer 108 and the air passage 122 may be defined by the structure 114 and the inner frame layer 110.

The air passage 122 is fluidly coupled with one or more air passages 124 that are among the rotor 102. In the illustrated embodiment, a plurality of air passages is defined by the rotor. In other words, the air passage 124 may be positioned within or adjacent the rotor. Air flows from the air passage 124 among the rotor 102 to the air passage 122 between the inner frame layer 110 and the outer frame layer 108 and across the liquid coolant passage 116 to transfer heat from the rotor 102 and the stator 104 to liquid coolant flowing through the liquid coolant passage 116. In this way, a combination of liquid cooling and air cooling is applied to cool the electric motor 100.

In an embodiment, a fan 126 is operatively coupled to the rotor 102. The fan 126 is configured to blow air through the air passage 124 during rotation of the rotor 102 to increase air flow across the liquid coolant passage 116 in order to increase cooling performance of the electric motor 100. Since the fan 126 is operatively coupled to the rotor 102, the fan 126 may rotate without separate power during operation of the electric motor 100. In this way, the fan 126 may provide air cooling without the need for external power to operate the fan 126. However, the fan 126 need not be coupled to the rotor 102. In some embodiments, the fan 126 is operable by power from a separate power source.

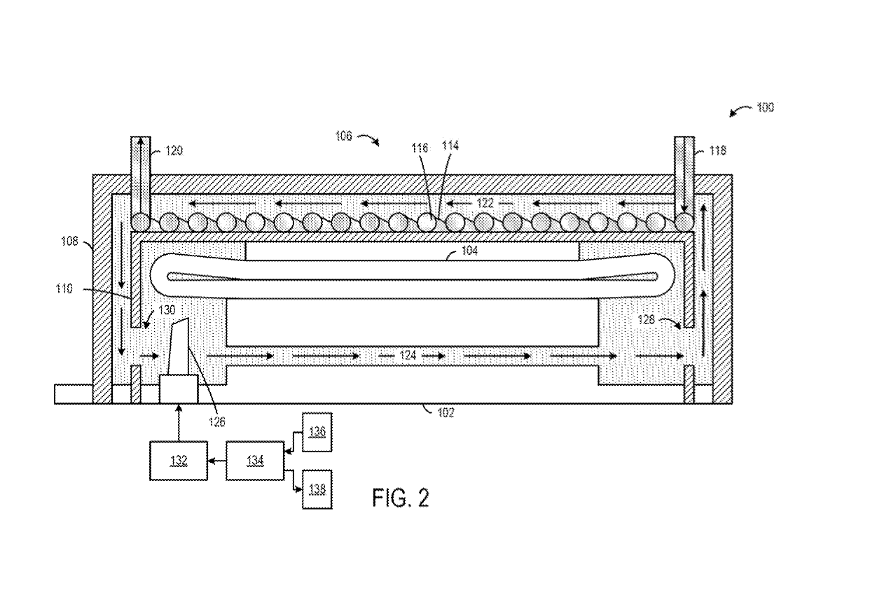

FIG. 2 shows a partial cross-sectional view of the electric motor 100 that is perpendicular to the cross-sectional view of FIG. 1. More particularly, this view shows a detailed view of the liquid coolant passage 116 and a path of air flow within the electric motor 100. In one example, the liquid coolant passage 116 helically encircles the inner frame layer 110. In other words, the structure 114 that defines the liquid coolant passage 116 comprises a helical shape that coils around the inner frame layer 110. The structure 114 that defines the liquid coolant passage 116 is coupled to the inner frame layer 110 for air to flow between the liquid coolant passage 116 and the outer frame layer 110 to cool the electric motor 100. Moreover, heat generated from electromagnetic induction in the stator 104 may be transferred through the inner frame layer 110 to the liquid coolant passage directly as opposed to being transferred through air that travels across the liquid coolant passage.

It will be appreciated that the structure 114 may define a suitable number of coils that encircle the inner frame layer 110 without departing from the scope of the present description. In some embodiments, the structure 114 defines a plurality of coils that are spaced apart. In some embodiments, the structure 114 defines a plurality of coils that are not spaced apart, but instead are coupled to or touch each other. It will be appreciated that the coils may assume various suitable forms without departing from the scope of the present description. For example, each of the plurality of coils may be round. In another example, each of the plurality of coils may be square. The shape of the structure 114 may be dependent on manufacturing cost, cooling performance (e.g., surface area to contact air flow, coolant flow rate), etc. In some embodiments, fins may be welded to the structure 114 that defines the liquid coolant passage to increase the heat transfer performance. In embodiments, the structure 114 may comprise alloy or other metal tubing, helically wound or otherwise.

The liquid coolant passage 116 comprises the coolant inlet 118 configured to receive liquid coolant from the exterior environment and the coolant outlet 120 to expel the liquid coolant from the liquid coolant passage to the exterior environment. The coolant inlet 118 and the coolant outlet 120 extend beyond the frame 106 to interface with other liquid coolant components (e.g., coolant hoses). Liquid coolant is pumped through the liquid coolant passage 116 to transfer heat from the internal components of the electric motor 100 to the external environment without exposing the internal components themselves to the external environment. In the illustrated embodiment, the coolant inlet 118 and the coolant outlet 120 are positioned at opposing ends of the frame 106 with the plurality of coils positioned between the coolant inlet 118 and the coolant outlet 120. It will be appreciated that the coolant inlet and the coolant outlet may be positioned at various suitable positions on the frame without departing from the scope of the present description.

In some applications, the electric motor 100 is stationary and is operated in the atmosphere and not immersed in water. As such, the electric motor 100 cannot be passed through water to provide cooling. Instead, water or another liquid coolant is brought to the electric motor 100 for cooling. In one particular example, the electric motor 100 is positioned on or near salt water, such as on an ocean or a coastline and salt water is pumped to the electric motor 100 to act as the liquid coolant. As such in some embodiments, the structure 114 that defines the liquid coolant passage comprises a copper-nickel alloy and the liquid coolant comprises salt water that is pumped into the coolant inlet 118. The copper-nickel alloy may reduce the rate of corrosion of the structure 114 by the salt water to prolong the operational life of the electric motor 100. In other embodiments, the alloy is a type of metal composition other than copper-nickel, which is resistant to corrosion by salt water (e.g., stainless steel, certain compounds of aluminum) versus other possible materials. In other embodiments, the structure that defines the liquid coolant passage is non-metallic (e.g., polymer) or partially non-metallic (e.g., polymer coated alloy).

The inner frame layer 110 comprises a first opening 128 to allow air from the air passage 124 among the rotor 102 to flow between the inner frame layer 110 and the outer frame layer 108 and across the liquid coolant passage 116. In particular, the first opening 128 in the inner frame layer 110 fluidly couples the air passage 124 among the rotor 102 with the air passage 122 that is positioned between the inner frame layer 110 and the outer frame layer 108. Further, the inner frame layer 110 comprises a second opening 130 to allow air to flow from across the liquid coolant passage 116 to the air passage 124. In particular, the second opening 130 in the inner frame layer 110 fluidly couples the air passage 122 that is positioned between the inner frame layer 110 and the outer frame layer 108 with the air passage 124 among the rotor 102. The first opening 128 is positioned on a first side of the inner frame layer 110 and the second opening 130 is positioned on a second side of the inner frame layer 110 that opposes the first side. The opposing openings create an air cooling circuit where hot air circulates from the air passage 124 among the rotor 102, through the first opening 128 to the air passage 122. Air in the air passage 122 travels across the liquid coolant passage 116 and transfers heat from the air to the liquid coolant. Further, the cooled air travels from the air passage 122 through the second opening 130 to the air passage 124 among the rotor 102 to complete the air cooling circuit.

In some embodiments, the outer frame layer 110 seals the air passage 122 and the air passage 124 off from the exterior environment. In other words, the internal components of the electric motor 100 are sealed off from the exterior environment. By providing the liquid coolant passage 116 and the air passages 122 and 124, the internal components of the electric motor may be sufficiently cooled without exposing the internal components to the exterior environment and associated environmental conditions that potential shorten the operational life of the electric motor.

The fan 126 is configured to blow air through the air passage 124 in order to circulate air through the air passage 122 and across the liquid coolant passage 116. The fan 126 is operatively coupled to the rotor 102 to blow air during rotation of the rotor 102. In other words, when the rotor 102 is rotating during operation of the electric motor 100, the fan 126 is also rotating to blow air. In some embodiments, when the rotor 102 is not rotating, the fan 126 is not rotating and does not blow air. It will be appreciated that in some embodiments, the fan is not coupled to the rotor and rotates independent of rotation of the rotor.

In some embodiments, the fan 126 is operatively coupled with a power source 132 and the fan 126 is operable by power provided from the power source 132 when the rotor 102 is rotating at a low speed or not rotating. In some embodiments, the power source 132 is coupled to a controller 134. The controller 134 may be a microcomputer, including a microprocessor unit, input/output ports, an electronic computer readable storage medium for executable programs and methods described herein, such as a read only memory chip in a particular example, random access memory, and a data bus. The controller 134 is coupled to one or more sensors 136 that provide indications of one or more operating parameters of the electric motor 100 to the controller 134. The controller is coupled to one or more actuators 138, and the controller 134 is configured to operate the one or more actuators 138 based on the operating parameters indicated by signals received from the one or more sensors 136.

In one example, the controller 134 is configured to rotate the fan 126 using power from the power source 132 based on an operating parameter to cool the electric motor 100. Examples of operating parameters comprise internal temperature of the electric motor, ambient temperature, etc. In some cases, the controller 134 operates the fan 126 with power from the power source 132 when the rotor 102 is not rotating to provide cooling when the electric motor 100 is not operating. In one example, the sensor 136 comprises a temperature sensor and the controller 134 is configured to operate the fan 126 with power from the power source 132 when the electric motor 100 is not operating and an indication of the temperature received from the temperature sensor is greater than a temperature threshold. In another example, the actuator 138 is a coolant pump that is operable to pump liquid coolant through the liquid coolant passage 116, and the controller 134 is configured to operate the coolant pump when an indication of temperature received from the temperature sensor is greater than a temperature threshold.

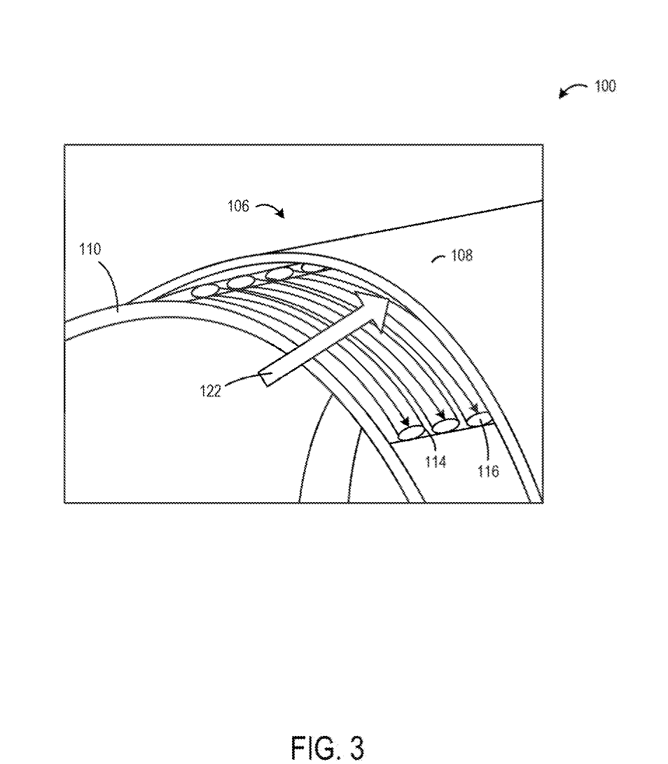

FIG. 3 shows a partial cut-away view of the frame 106 for the electric motor 100, according to an embodiment of the present description. In this embodiment, the liquid coolant passage 116 helically encircles the inner frame layer 110 of the frame 106. The air passage 122 is positioned between the outer frame layer 108 and the inner frame layer 110 and across the liquid coolant passage 116. In the illustrated embodiment, liquid coolant flows through the liquid coolant passage 116 in a first direction and the air that flows through the air passage 122 and across the liquid coolant passage 116 flows in a second direction that is different than the first direction. More particularly, the second direction is substantially perpendicular to the first direction. By arranging the liquid coolant passage 116 and the air passage 122 to have different flow directions, the heat transfer between the air and the liquid coolant may be increased relative to an arrangement where the fluids flow in the same direction.

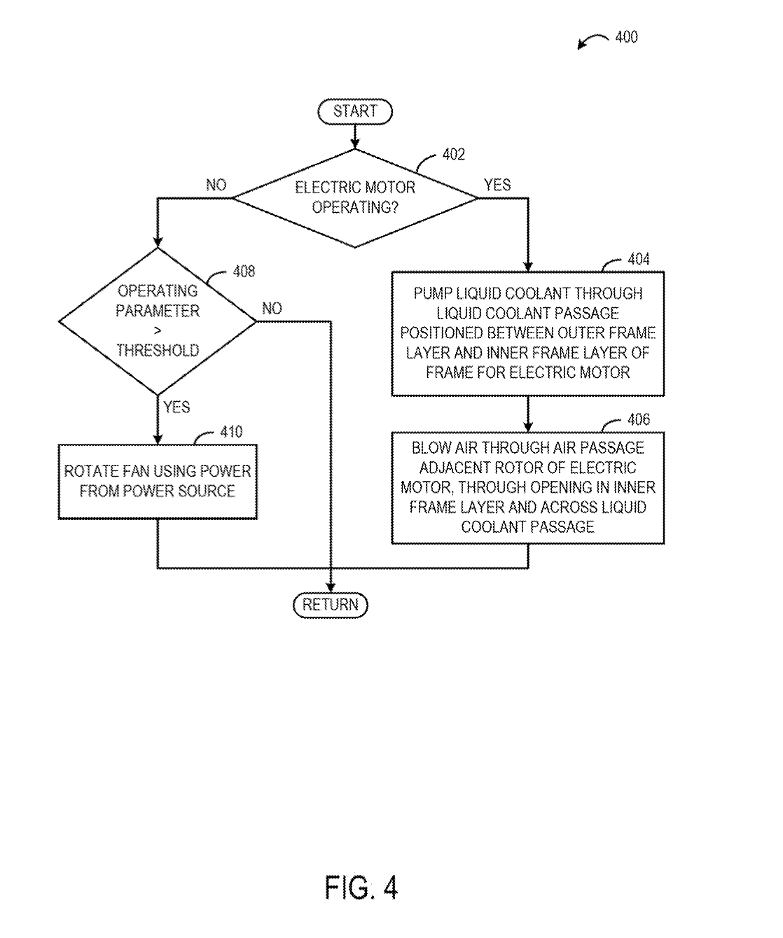

FIG. 4 shows an embodiment of a method 400 for cooling an electric motor. In one example, the method is implemented with the electric motor 100 shown in FIGS. 1-3. In one example, the method is performed by the controller 134 shown in FIG. 2. At 402, the method 400 comprises determining if the electric motor is operating. Operation of the electric motor comprises rotation of rotor to provide torque output. If the electric motor is operating, then the method 400 moves to 404. Otherwise, the method 400 moves to 408.

At 404, the method 400 comprises pumping a liquid coolant through a liquid coolant passage positioned between an outer frame layer and an inner frame layer of a frame for the electric motor. Liquid coolant is pumped through the liquid coolant passage to expel heat from internal components of the electric motor to the exterior environment in order to cool the electric motor. In one example, a liquid coolant pump may be controlled to pump liquid through the liquid coolant passage during operation of the electric motor.

At 406, the method 400 comprises blowing air through an air passage among a rotor of the electric motor, through an opening in the inner frame layer, and across the liquid coolant passage to cool the electric motor. In one example, a fan is configured to blow air through the air passage. In some embodiments, the fan is operatively coupled to the rotor to blow air during rotation of the rotor. The rotor produces heat during rotation through friction as well as by generating electromagnetic induction. By blowing air from the interior of the electric motor among the rotor across the liquid coolant passage, heat generated by the rotor may be transferred to the liquid coolant through circulation of the air within the interior of the electric motor. Accordingly, a combination of air cooling and liquid cooling may be implemented to cool the electric motor

When the electric motor is not operating, cooling operations may be performed based on one or more operating parameters of the electric motor. For example, at 408, the method 400 comprises determining if an operating parameter is greater than an operating parameter threshold. In one example, the operating parameter is the internal temperature of the electric motor. If the internal temperature of the electric motor is greater than a threshold temperature, then the method 400 moves to 410. Otherwise, the method 400 returns to other operations.

At 410, the method 400 comprises rotating the fan using power from a power source when the electric motor is not operating to blow air through the air passage in order to cool the electric motor. In some embodiments, the method may comprise pumping liquid coolant through the liquid coolant passage when the electric motor is not operating and the temperature is greater than the temperature threshold. In some embodiments, the fan may blow air and/or the liquid coolant may be pumped until the electric motor is cooled to below the temperature threshold or for a predetermined period. In some cases, residual heat in the electric motor may remain high even when the electric motor is not operating. In order to cool the electric motor to a suitable temperature, the fan may be operated with power from the power source when the electric motor is not operating in order to cool the electric motor to a suitable temperature.

In embodiments, the liquid coolant passage is positioned at least partially elsewhere than between the inner frame layer and the outer frame layer. For example, the liquid coolant passage could be positioned just radially inwards from the inner frame layer, or the liquid coolant passage could be imbedded within the inner frame layer, or the inner frame layer could define the liquid coolant passage. Thus, another embodiment relates to an electric motor. The electric motor comprises a stator and a rotor, wherein an air passage is formed between the stator and the rotor. The electric motor further comprises a frame comprising an outer frame layer and an inner frame layer, and a liquid coolant passage at least partially positioned within an interior of the electric motor defined by the outer frame layer. (That is, the outer frame layer defines an interior that partially or fully houses the stator, rotor, inner frame layer, etc., and the liquid coolant passage is at least partially positioned within this interior.) The inner frame layer comprises a first opening to allow air from the air passage to travel between the inner frame layer and the outer frame layer and across the liquid coolant passage.

In another embodiment, an electric motor comprises a frame comprising an outer frame layer and an inner frame layer positioned within an interior of the outer frame layer. For example, the inner frame layer may be concentric to the outer frame layer. The electric motor further comprises a stator at least partially positioned within an interior of the inner frame layer, and a rotor operably coupled with the stator. The electric motor further comprises a structure that defines a liquid coolant passage; the structure is positioned within the interior of the outer frame layer. Examples of possible structures are described above. The outer frame layer and the inner frame layer define an air passage fluidly coupling a space between and/or around the stator and rotor with an exterior of the structure. This allows for transfer of heat from heated air from the rotor and stator to a liquid coolant within the liquid coolant passage when the electric motor is in operation. (The electric motor may include additional aspects as described elsewhere herein.)

In another embodiment, the liquid coolant passage is not fluidly coupled with the air passage, that is, air in the air passage does not comingle within the motor with coolant in the coolant passage. In another embodiment, the structure defining the liquid coolant passage includes an inlet structure defining a liquid coolant inlet potion of the passage, and an outlet structure defining a liquid coolant outlet portion of the passage. The inlet and outlet run external to the motor, allowing for relatively cooler coolant to be provided to the coolant passage from external to the motor and for relatively warmer coolant (e.g., heated due to receiving heat from the air in the motor) to be removed from the coolant passage to external to the motor. In another embodiment, the structure defining the liquid coolant passage extends along all or part of an axial length of the inner frame layer and/or stator/rotor. In another embodiment, the structure defining the liquid coolant passage is concentric with the rotor/stator, that is, the rotor/stator are coaxial with and positioned within an interior region defined by the structure. For example, as noted above, the structure may helically wind around the rotor/stator periphery.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may comprise other examples that occur to those of ordinary skill in the art. Such other examples are intended to be within the scope of the claims if they have structural elements that do not differ from the literal language of the claims, or if they comprise equivalent structural elements with insubstantial differences from the literal languages of the claims.

What is claimed is:

1. A frame for an electric motor, the frame comprising:
an outer frame layer;
an inner frame layer; and
a liquid coolant passage positioned between the inner frame layer and the outer frame layer, wherein the inner frame layer comprises a first opening to allow air from an air passage among a rotor of the electric motor to flow between the inner frame layer and the outer frame layer and across the liquid coolant passage.

2. The frame of claim 1, wherein the inner frame layer comprises a second opening to allow air to flow from across the liquid coolant passage to the air passage.

3. The frame of claim 2, wherein the first opening is positioned on a first side of the inner frame layer and the second opening is positioned on a second side of the inner frame layer that opposes the first side.

4. The frame of claim 1, wherein the outer frame layer seals the air passage off from an exterior environment.

5. The frame of claim 1, wherein the liquid coolant passage helically encircles the inner frame layer.

6. The frame of claim 1, wherein a structure that defines the liquid coolant passage is coupled to the inner frame layer for air to flow between the liquid coolant passage and the outer frame layer.

7. The frame of claim 1, wherein the liquid coolant passage comprises a coolant inlet configured to receive a liquid coolant from an exterior environment and a coolant outlet to expel the liquid coolant from the liquid coolant passage to the exterior environment.

8. The frame of claim 7, wherein a structure that defines the liquid coolant passage comprises an alloy and the liquid coolant comprises salt water that is pumped into the coolant inlet.

9. An electric motor comprising:
a stator;
a rotor, wherein an air passage is formed between the stator and the rotor;
a frame comprising an outer frame layer and an inner frame layer; and
a liquid coolant passage positioned within an interior of the electric motor defined by the outer frame layer, wherein the inner frame layer comprises a first opening to allow air from the air passage to travel between the inner frame layer and the outer frame layer and across the liquid coolant passage.

10. The electric motor of claim 9, wherein the liquid coolant passage is positioned between the inner frame layer and the outer frame layer.

11. The electric motor of claim 10, further comprising a fan configured to blow air through the air passage, wherein the fan is operatively coupled with a power source and the fan is operable by power provided from the power source when the rotor is not rotating.

12. The electric motor of claim 10, further comprising a fan configured to blow air through the air passage, wherein the fan is operatively coupled to the rotor to blow air during rotation of the rotor.

13. The electric motor of claim 10, wherein the inner frame layer comprises a second opening to allow air to flow from across the liquid coolant passage to the air passage.

14. The electric motor of claim 13, wherein the first opening is positioned on a first side of the inner frame layer and the second opening is positioned on a second side of the inner frame layer that opposes the first side.

15. The electric motor of claim 10, wherein the outer frame layer encloses the air passage off from an exterior environment.

16. The electric motor of claim 10, wherein the liquid coolant passage helically encircles the inner frame layer.

17. The electric motor of claim 10, wherein the liquid coolant passage comprises a coolant inlet configured to receive a liquid coolant from an exterior environment and a coolant outlet to expel the liquid coolant from the liquid coolant passage to the exterior environment.

18. The electric motor of claim 17, wherein a structure that defines the liquid coolant passage comprises an alloy and the liquid coolant comprises salt water that is pumped into the coolant inlet.

19. An electric motor comprising:
a frame comprising an outer frame layer and an inner frame layer positioned within an interior of the outer frame layer;
a stator at least partially positioned within an interior of the inner frame layer;
a rotor operably coupled with the stator; and
a structure that defines a liquid coolant passage, the structure positioned within the interior of the outer frame layer;
wherein the outer frame layer and the inner frame layer define an air passage fluidly coupling a space between and/or around the stator and rotor with an exterior of the structure, for transfer of heat from heated air from the rotor and stator to a liquid coolant within the liquid coolant passage when the electric motor is in operation.

20-22. (canceled)
